(19) United States
(12) Patent Application Publication
(10) Pub. No.: US 2024/0246840 A1
(43) Pub. Date: Jul. 25, 2024

(54) SYSTEM FOR TREATING WASTEWATER FROM ELECTRONICS AND SEMICONDUCTOR FABRICATION FACILITIES

(71) Applicant: Samco Technologies, Inc., Buffalo, NY (US)

(72) Inventors: Matthew J Burger, Depew, NY (US); Emily Akins, Eagan, MN (US); Richard Peacock, Hillsboro, OR (US); Robert Bellitto, East Aurora, NY (US)

(21) Appl. No.: 18/528,167

(22) Filed: Dec. 4, 2023

Related U.S. Application Data
(63) Continuation of application No. 18/304,961, filed on Apr. 21, 2023, now abandoned.
(60) Provisional application No. 63/363,414, filed on Apr. 22, 2022.

(51) Int. Cl. C02F 1/66; B01F 23/80; B01F 25/40; B01F 25/51; B01F 25/53; B01F 27/113; B01F 33/82; B01F 35/21; B01F 101/00; C02F 1/00; C02F 1/68; C02F 103/34

(52) U.S. Cl. CPC C02F 1/66; B01F 23/808; B01F 25/40; B01F 25/51; B01F 25/53; B01F 27/113; B01F 33/8212; B01F 35/2111; B01F 35/2113; B01F 35/2115; B01F 35/2132; C02F 1/004; C02F 1/008; C02F 1/686; B01F 2101/305; C02F 2103/346; C02F 2209/02; C02F 2209/03; C02F 2209/06; C02F 2209/40; C02F 2301/046

(57) ABSTRACT

A system for treating wastewater from electronics and semiconductor companies that has at least one reactor tank assembly and at least one wastewater conveyance kit of inflow, outflow, and return flow pipe, valve, and pump assemblies. The at least one reactor tank assembly is interchangeably operable at least one or more of singly, as a series of reactor tank assemblies, and parallel with other reactor tank assemblies. At least one mixer assembly is operationally disposed within the reactor tank assembly and is designed to mix the wastewater in the reactor tank assembly. At least one pH computer-monitored sensor assembly is disposed at least partially within the wastewater flow. At least one or more of acid and caustic from respective storage tanks is used to change the pH of the wastewater until treated and suitable for discharge.

### CROSS-REFERENCE TO RELATED APPLICATIONS

This application claims priority to and the benefit of U.S. application Ser. No. 18/304,961 titled SYSTEM FOR TREATING WASTEWATER FROM ELECTRONICS AND SEMICONDUCTOR FABRICATION FACILITIES filed on Apr. 21, 2023, which claims benefit of Provisional U.S. application 63363414 titled SYSTEM FOR TREATING WASTEWATER FROM ELECTRONICS AND SEMICONDUCTOR FABRICATION FACILITIES filed on Apr. 22, 2022, which are incorporated herein by reference in their entireties.

### FIELD OF THE INVENTION

The present inventive concept relates to a system for treating wastewater, especially wastewater from electronics and semiconductor fabrication facilities, but inclusive of other facility types.

### BACKGROUND

Electronics, semiconductor companies, and many other enterprises use acid waste neutralization systems (AWN) to treat millions of gallons of wastewater that may flow from their fabrication facilities every day. Substantially non-particulate wastewater is deionized. The pH of this wastewater can have a wide range from high to low. By regulation, the pH for discharge must be about 7.0.

A conventional wastewater treatment system for acid waste neutralization has two to three reactor tank assemblies in series which will have a wastewater retention time during treatment of 30 minutes to 90 minutes. These reactor tank assemblies may hold more than one hundred thousand gallons of wastewater and handle flows typically between 1,000 to 10,000 gallons per minute (GPM). Further, these reactor tank assemblies have mixers mounted on the top and acid and caustic conveyance systems to neutralize the water to an acceptable band straddling 7.0 pH.

Saving space is important in fabrication facilities where production is environmentally controlled and creating new space can be difficult. Conventional systems have several disadvantages. 1) The size of a system of wastewater treatment reactor tank assemblies able to handle 2,500 GPM is about 30 feet wide, 100 feet long, and 30 to 50 feet tall. This footprint involves more than one reactor, each reactor having a radius of about 15 feet. 2) The wastewater treatment systems are built on-site because many of the components, if preassembled, are too big to carry over most roadways. Onsight production drives up costs, and production time is higher than might be achieved using shop fabrication efficiencies. 3) Reactor tank assemblies typically operate at 100% capacity. There is no flow equalization, which means the system is limited to and must be able to handle the peak flow being fed from the fabrication facility. 4) The whole wastewater treatment system is designed to use gravity to power outflow, which requires ensuring all conveyances are designed such that gravity feeds the system inflow and outflow. 5) With the wastewater treatment system already being designed to handle peak flows expected from each given fabrication facility during installation, expanding a fabrication facility can prove difficult because of the need to increase the capacity of the existing wastewater treatment system and the need to address what may be limited sewer capacity and a limited available installation footprint for expanding the wastewater treatment system.

Therefore, there is a need in the market for an improved wastewater treatment system for electronics and semiconductor fabrication facilities that eases the ability to expand water treatment capacity and lowers both the footprint of equipment and the water pressure required to convey wastewater through the system.

### SUMMARY OF THE INVENTION

Disclosed is a wastewater treatment system and method for electronics and semiconductor fabrication facilities designed, in one embodiment—through time-efficient kinetics that reduce wastewater retention in the system from 10 to 30 minutes to 5 to 15 minutes—to reduce the footprint from 25 feet by 100 feet for a conventional wastewater treatment system to about 25 feet by 25 feet for the disclosed wastewater treatment system. Comparable reductions may take place for other embodiments of different sizes. The shorter wastewater retention time for the representative embodiment reduces the footprint of a 2,500 GPM system to 25 by 25 feet for a single train reactor tank assembly system or 25 by 50 feet for a two-train reactor tank assembly system.

In one embodiment of the disclosed wastewater treatment system, the reactors are designed to have a buffer zone suitable for holding variable wastewater levels. This means fabrication facilities can use smaller reactors, level controls, and variable speed circulation pump assemblies to manage the wastewater treatment process and accommodate varied wastewater flows.

In one embodiment of the disclosed wastewater treatment system, at least one circulation pump assembly is used to mix and recycle wastewater while the system adjusts for pH levels that are higher or lower than permitted pH levels for discharging. Mixing assemblies in some embodiments include rotary mixers having at least one blade. Mixing, in some embodiments, is conducted or further conducted by reactor tank assembly eductor mixers disposed at the bottom of each reactor tank assembly. Mixing eductors, where present, are further used to leverage pressure and water flow. In one embodiment, 2 to 10 mixing eductors increase wastewater mixing beyond the circulation produced by circulation pump assemblies alone. Therefore, in these embodiments, water flows are created without requiring mechanical—propeller-based—mixers.

Embodiments of the disclosed wastewater treatment system are designed to be compact enough to allow prefabricated systems to be shipped by truck over a typical roadway. As such, the disclosed wastewater treatment system may be produced by way of pre-engineered and prepackaged modules and may be constructed in parallel with preparing the installation site at the receiving electronics and semiconductor fabrication facility.

Embodiments of the disclosed wastewater treatment system forgo depending on gravity to move wastewater in favor of pumping wastewater through the lines of a pipe system. Flows can be increased over existing piping by increasing water flow pressure.

Embodiments of the disclosed wastewater treatment system afford modularity and associated expandability. In addition, installing parallel trains of reactor systems as needed can also ease system expansion when compared to conventional, gravity-based systems of similar capacity.

Embodiments of the disclosed wastewater treatment system are designed to be operationally flexible by having capacity buffers designed to handle and manage variable wastewater flows. Multiple reactor tank assemblies of the disclosed wastewater treatment system may be installed in series for fine-tuning wastewater output, or multiple reactor tank assemblies may be installed in parallel, allowing flows to substantially double over a single reactor tank assembly system for each parallel installation of a reactor tank assembly. Multiple reactor tank assembly trains correspondingly increase available wastewater flow capacities. In one embodiment of the wastewater system, wastewater treatment flows may be set as required to flow through multiple reactor tank assembly trains either or both sequentially and in parallel, with a flow variability from about 2,500 GPM to 10,000 GPM.

One embodiment of the system for treating wastewater has at least one reactor tank assembly. The at least one reactor tank assembly is operable at least one or more of singly, as a series of reactor tank assemblies, and parallel with other reactor tank assemblies. At least one inflow pipe and valve assembly is coupled to the at least one reactor tank assembly and is designed to direct wastewater into the at least one reactor tank assembly through at least one inlet header port assembly disposed on a top portion of the reactor tank assembly. At least one outflow pipe and valve assembly is coupled by at least one outlet port assembly of the at least one reactor tank assembly and is designed to direct wastewater out from the at least one reactor tank assembly. At least one return flow pipe and valve assembly of the at least one outflow pipe and valve assembly is designed to direct, as required, at least a portion of the wastewater flowing out from the at least one reactor tank assembly back into the at least one reactor tank assembly.

In this embodiment of the system for treating wastewater, the at least one circulation pump assembly is disposed on the at least one outflow pipe and valve assembly. There is, in this embodiment, at least one carrier-injector pump assembly. The at least one carrier-injector pump assembly is designed to pump a portion of—in one embodiment this being between about 10 to 50 GPS—of the wastewater fed to it as a secondary stream of wastewater flowing through the at least one outflow pipe and valve assembly.

In one embodiment of the system for treating wastewater, the eductor mixer assembly is operationally disposed on a bottom portion of the at least one reactor tank assembly and is designed to mix wastewater in the reactor tank assembly, inclusive, when present, of wastewater drawn from the reactor tank assembly and reintroduced into the reactor tank assembly through the at least one return flow pipe and valve assembly.

In one embodiment of the system for treating wastewater, at least one pH sensor assembly is disposed at least partially within the wastewater flow and is operationally coupled to at least one computer system, the at least one computer system is designed to control introducing at least one or more of acid from an at least one acid storage reactor tank and valve assembly operationally coupled to the wastewater flow and a caustic from an at least one caustic storage reactor tank and valve assembly operationally coupled to the wastewater flow, the at least one or more acid and caustic used to treat the wastewater by changing the pH of the wastewater. The at least one or more acid and caustic is introduced to the wastewater as the wastewater flows through one or more streams of the outflow pipe and valve assembly until, through one or more treatments, the wastewater is suitable for discharge.

In one embodiment of the system for treating wastewater, at least one static mixer is disposed on the outflow pipe and valve assembly, and at least one pH sensor is disposed on the outflow pipe and valve assembly following the static mixer. The at least one pH sensor is designed to test wastewater pH after the wastewater has passed through the static mixer, wherein if the pH is inclusively between 5.0 and 8.0, a selector valve assembly opens and allows the wastewater to flow out of the system for treating wastewater and to a sewer system. If the pH is less than 5.0 or greater than 8.0, the selector valve assembly closes and directs wastewater to flow back into the reactor tank of origin.

The inventive concept now will be described more fully hereinafter with reference to the accompanying drawings, which are intended to be read in conjunction with both this summary, the detailed description, and any preferred and/or particular embodiments specifically discussed or otherwise disclosed. This inventive concept may however, be embodied in many different forms and should not be construed as limited to the embodiments set forth herein; rather, these embodiments are provided by way of illustration only and so that this disclosure will be thorough, complete, and will fully convey the full scope of the inventive concept to those skilled in the art.

### BRIEF DESCRIPTION OF THE DRAWINGS

FIG. 1 illustrates a representative single-unit acid waste neutralizer.

FIG. 2 illustrates a representative duplex acid waste neutralizer.

FIGS. 3A and 3B illustrate a representative embodiment of the pipe and valve assembly for directing wastewater to and from reactor tank assemblies.

FIG. 4 illustrates a conventional acid waste neutralizer.

FIGS. 5A and 5B illustrate a representative method for treating wastewater with at least one representative acid waste neutralizer.

FIG. 6 illustrates a representative arrangement of reactor tank assemblies.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in numerous ways, as the subject matter is not limited to any particular manner of implementation. Examples of specific implementations and applications are provided primarily for illustrative purposes.

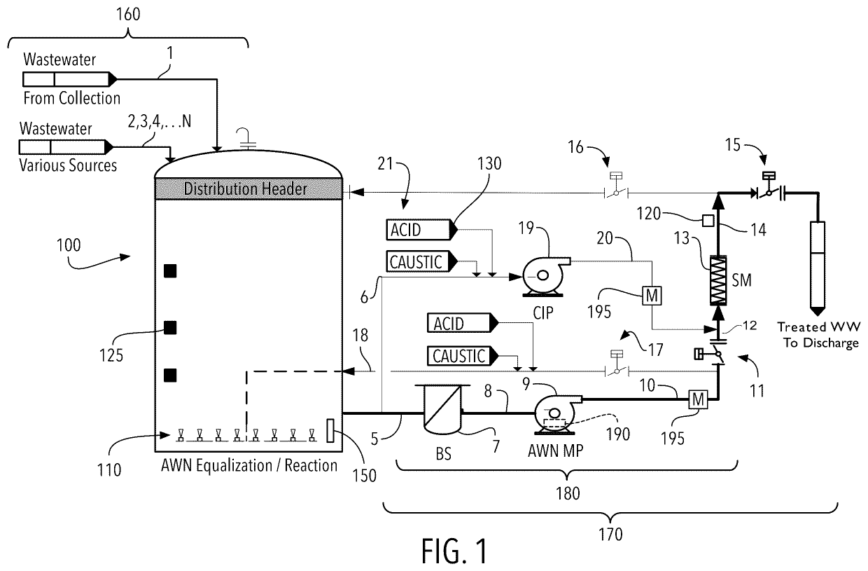

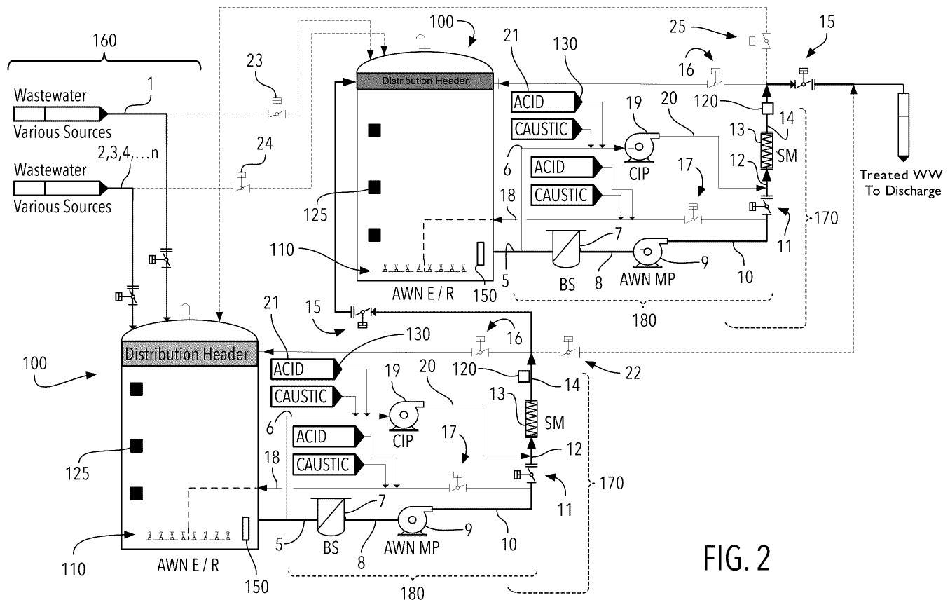

FIGS. 1 and 2 illustrate that in one representative embodiment of the wastewater treatment system, wastewater flows from various sources in the fabrication facility 1, 2, 3, 4 . . . N to a reactor tank assembly 100 through an inlet port assembly. The flow is typically

DI water, but may include other types of wastewater from fabrication facilities, DI which is water purified to remove substantially all mineral ions such as cations like sodium, calcium, iron, and copper, and anions such as chloride and sulfate. The characterization of these streams and associated pH varies from acidic at 0.50 pH to basic at over 10.0 pH.

FIGS. 1 and 2 further illustrate that in the representative embodiment, at least one inflow pipe and valve assembly 160 directs wastewater to the at least one reactor tank. At least one outflow pipe and valve assembly 170 directs wastewater out from the at least one reactor tank. At least one return flow pipe and valve assembly 180 of the at least one outflow pipe and valve assembly 170 directs, as required, at least a portion of the wastewater flowing out from the at least one reactor tank assembly 100 back into the at least one reactor tank assembly 100. The pipe and valve assemblies 160, 170, and 180 are operationally coupled to the at least one reactor tank assembly 100. A section of any pipe and valve assembly 160, 170, and 180 may be termed a line.

FIGS. 1 and 2 further illustrate that flows in various embodiments can be from near 0 GPM to a peak of 5,000 to 10,000 GPM. A typical module in the representative embodiment consists of at least one reactor tank assembly 100 and at least one conveyance kit inclusive of the pipe and valve assemblies 160, 170, and 180, which can be designed to handle anywhere from 1,000 to 5,000 GPM depending on the fabrication facility. FIGS. 1 and 2 further illustrate that in the representative embodiment, the design handles about 2,500 GPM. Wastewater flows into the first reactor tank assembly 100 and will have a residence time within the first reactor tank assembly 100 of about between 2 and 15 minutes, depending on the treatment taking place. The wastewater enters the reactor tank assembly 100 and goes into a distribution trough, or termed distribution header, where the wastewater is distributed evenly over the surface of the wastewater already in the reactor tank assembly 100. The wastewater is mixed with controlled amounts of a caustic or acid from respective at least one chemical storage reactor tank assemblies 21 and recycled water, the mixing of ample vigor to ensure substantially complete and substantially uniform end-result intermixing, to reach the treatment goals typically of a pH band between about 6.50 to 9.50 pH. At line 5, the wastewater then exits the reactor at approximately 1,000 to 3,000 GPM.

FIGS. 1 and 2 further illustrate that a second stream at line 6 in the representative embodiment stems from a stream at line 5 at a flow rate of about 10 to 50 GPM and is fed to a carrier injection pump assembly 19 for premixing and injecting the correct amount of blended pH adjustment acid and caustic to the inlet of the carrier injection pump assembly 19. An optional bag strainer 7 can be put within the line of wastewater flow to catch larger particles and debris that might otherwise clog pump assemblies. Caustic and acid can be added before or after the bag strainer 7 in different embodiments.

FIGS. 1 and 2 further illustrate that wastewater in the representative embodiment flows through line 8 to the inlet of a circulation pump assembly 9 for boosting the pressure in line 10 to drive eductor mixers 110 and mixing through at least one static mixer 13. Wastewater flows through valve 11, which modulates the flow through line 12 through the at least one static mixer 13, which mechanically mixes the pH fluid from line 20 and the feed flow from line 12 into a blended solution which flows through line 14. In one embodiment, about 10% to 50% additional flow can be used for recycling. Mixing assemblies in some embodiments include rotary mixers having at least one blade and may be of a propeller form. Such rotary mixers may be open propellers or may be housed within a substantially cylindrical assembly adapted to create a fan stream or jet stream. Some embodiments have more than one mixer type.

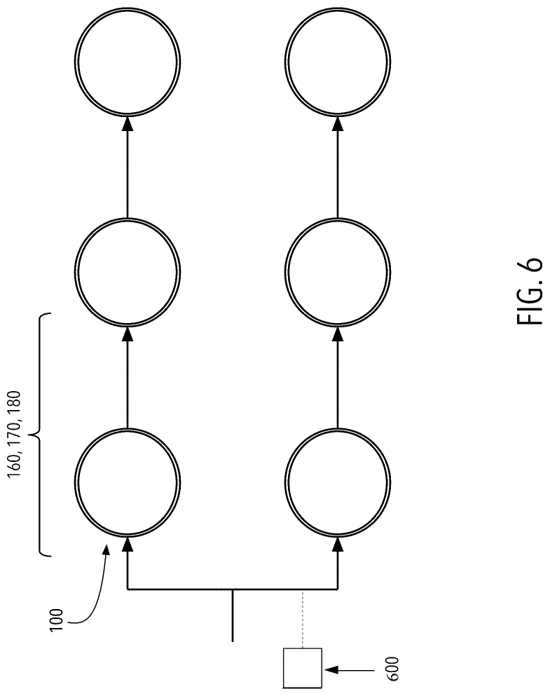

FIGS. 1 and 2 further illustrate that the pH of the wastewater in the representative embodiment is adjusted and, if within acceptable boundaries, is sent through selector valve 15 for discharge into a sewer or other outlet. Otherwise, valve 15 is closed, and valve 16 opens to recycle the wastewater back to reactor tank assembly 100 for further treatment. Valve 17 and valve 11 of the representative embodiment work together to maintain the proper balance of flow back to the eductors 110, which increase mixing by using eduction to amplify mixing flow and forward flow out of the system in line 18, wherein the caustic and acid are added as required in a mixture suitable to bring the pH at least closer to within the required boundaries. There is at least one water level sensor 125 disposed in each reactor tank assembly 100 and at least one pH sensor 120 designed to monitor wastewater flow pH and provide data signals to, as illustrated in FIG. 6, a programmable logic controller (PLC) 600 so that at least one computer system will monitor and manage the proper addition of chemicals into the wastewater flows to meet the treatment objectives of the operating facility. The wastewater treatment system is automated and driven by the PLC 600 to handle variations in process feeds and meet desired wastewater treatment goals. Data may be stored for further analysis, and the PLC 600 may be used for simulations to improve algorithms for controlling wastewater and treatment chemical flows, mixing, and timing.

FIGS. 1 and 2 further illustrate that line 6 of the representative embodiment feeds water to carrier injection pump assembly 19, the carrier injection pump assembly 19, which boosts the pressure and premixes caustic and acid as controlled by the computer system into line 20, which then feeds the mixture into line 12 to be blended with the water from line 10 through mixer 13 to deliver to line 14.

FIGS. 1 and 2 further illustrate that the system requires the acid or caustic solution to set pH within the desired limits. In the representative embodiment, these acid and caustic solutions are delivered under pressure from the respective at least one chemical storage reactor tank assemblies 21 to the wastewater flow, the acid and caustic solutions released through a release valve assembly 130, the release valve assembly 130 controlled by the at least one computer system designed to determine the measures to precisely deliver the acid and caustic chemicals to the wastewater treatment process as needed.

FIG. 2 further illustrates that, in the representative embodiment, line 22 can be opened to let wastewater flow directly from the illustrated first reactor train 100 to wastewater discharge. Line 22 is also used when reactor tank assemblies are reversed in the lead-lag arrangement. This use of line 22 further allows fabrication facilities to have both the illustrated reactor tank assemblies 100 of the representative embodiment operate in parallel or operate with a lead and lag sequential arrangement. In one embodiment, a normal operation is performed with both reactor tank assemblies 100 in series. Solid lines show flow paths with a first reactor tank assembly 100 in the lead and a second reactor tank assembly 100 in the lag position. Dashed lines show flow path with the second reactor tank assembly 100 in the lead and the first reactor tank assembly 100 in the lag position. Multiple duplex trains can be added in parallel to expand inlet flows.

FIG. 2 further illustrates that lines 23 and 24 of the representative embodiment are used to flow the wastewater from the fabrication facility to the representative second reactor tank assembly 100. Lines 23 and 24 afford the flexibility of having both modules operating in parallel or in sequence with a lead and lag.

FIG. 2 further illustrates that line 25 of the representative embodiment is used to divert wastewater from representative second reactor tank assembly 100 back to the representative first reactor tank assembly 100 when reversing the flow of the lead-lag arrangement. Changing between lead-lag and parallel flows can be performed manually or automatically.

FIGS. 1 and 2 further illustrate that motors 190 used in the representative embodiment, such as to operate pumps 9 and 19 of the wastewater treatment system, have variable speed controls. Valves, as represented by, but not limited to, 11, 15, 16, 17, 22, 23, and 24, are managed by the at least one computer system to balance flows and pressures to achieve treatment process objectives. Wastewater flows include discharging treated wastewater, receiving various wastewater streams at various pH levels and flows, precisely mixing acid and caustic chemicals, and sending wastewater to be discharged or recycled. Water level sensors 125 and pH sensors 120 may be disposed within reactor tank assemblies 100 as illustrated in the representative embodiment as well as pH sensors 120 disposed in various streams flowing through lines to monitor the pH of wastewater flows. Temperature sensors disposed within the at least one or more of the reactor tank assemblies 100 and pipe and valve assemblies 160, 170, and 180 measure temperature. Pressure sensors disposed within at least one or more of the reactor tank assemblies 100 and pipe and valve assemblies 160, 170, and 180 measure pressure.

If necessary, the wastewater treatment system may operate with a single reactor tank assembly 100, at which point wastewater from the single reactor tank assembly 100 is routed to a sewer or other depository without going through another reactor tank assembly 100. Off-spec return flows to the respective reactor tank assembly 100, in the representative embodiment, is used when one reactor tank assembly 100 is in service and if treated water pH exiting the static mixer 13 does not meet pH specifications.

Wastewater in the representative embodiment, often originating as Ultra-Pure Water (UPW), is delivered to the reactor tank assemblies 100 in separate lines as represented by lines 1, 2, 3, 4 . . . N. The system for treating wastewater from electronics or semiconductor fabrication facilities may be termed Acid Waste Neutralizers or AWN, given the prevalence of acids used at such facilities. Multiple duplex trains of reactor tank assemblies 100 can be added in parallel to expand inlet flow capacity, as illustrated in FIG. 6.

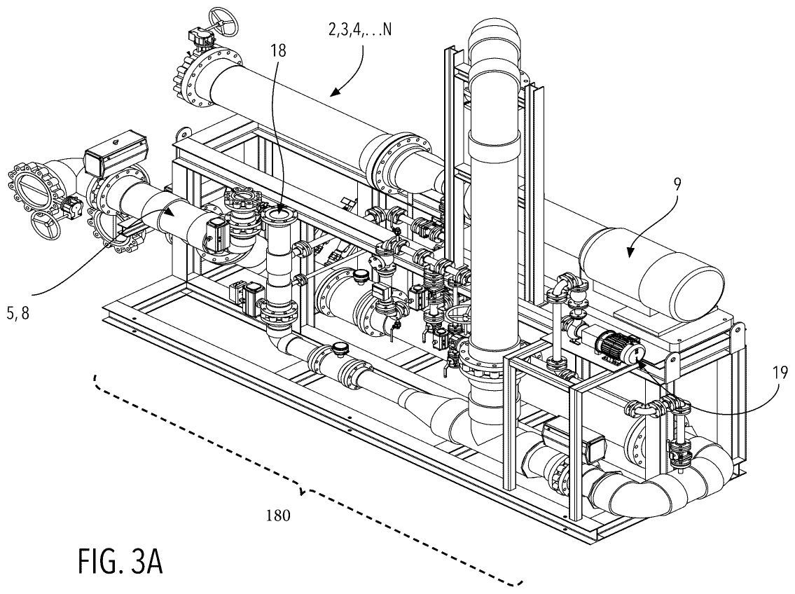

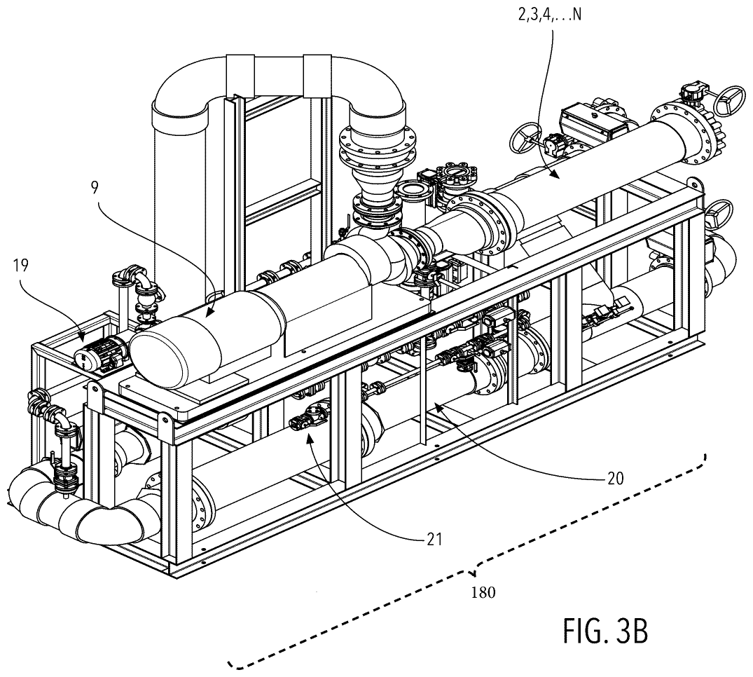

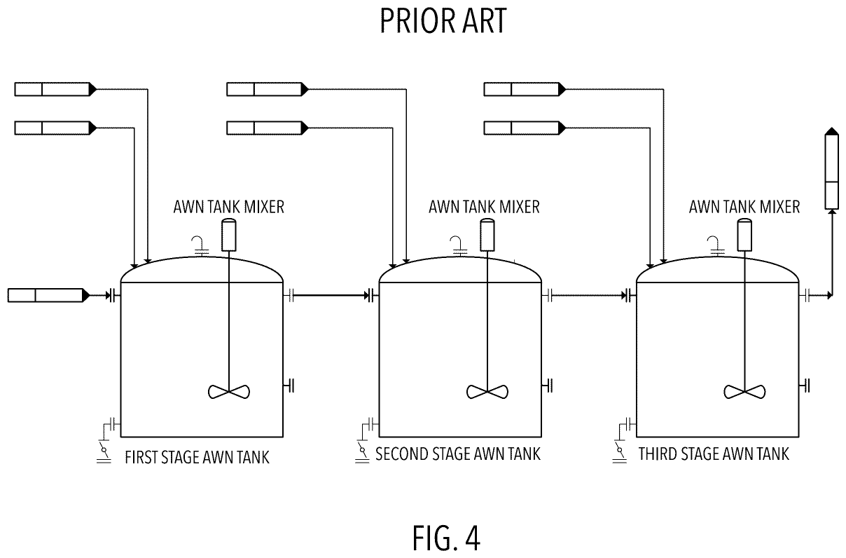

FIGS. 3A and 3B illustrate profile views of one representation of the return flow pipe and valve assembly 180 including wastewater flows from various sources in the fabrication facility 1, 2, 3, 4 . . . N, pumps 9 and 19, lines 5 and 8, lines 18 and 20, and chemical storage reactor tank assemblies 21.

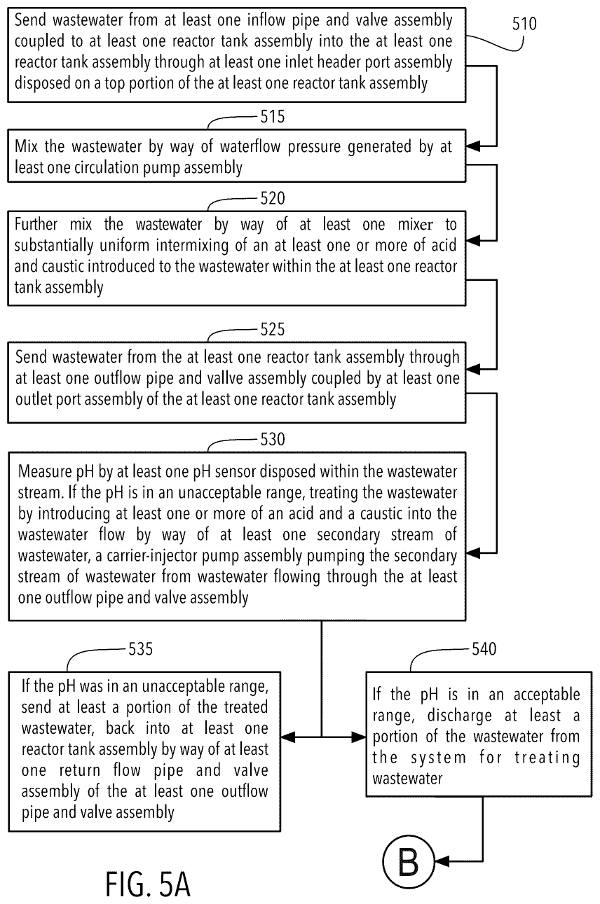

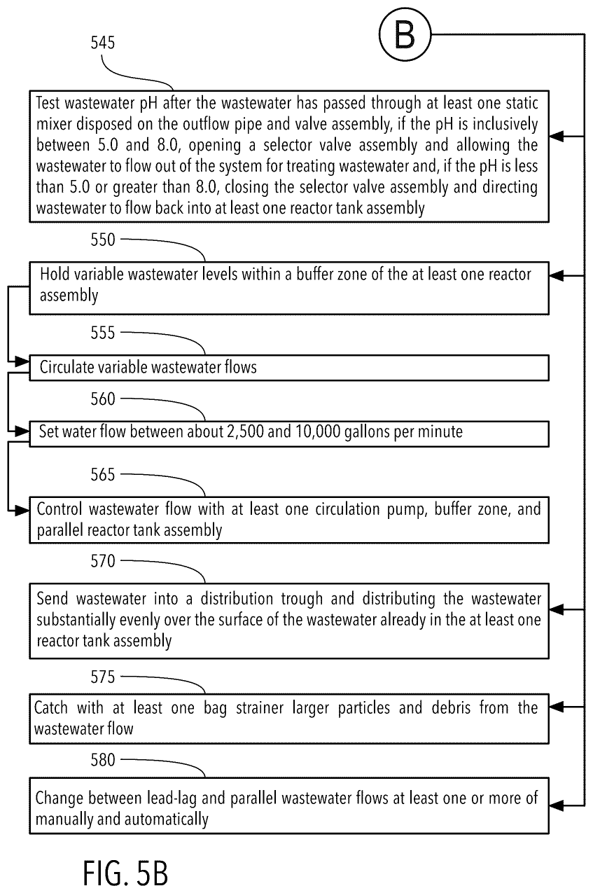

FIG. 5A and 5B illustrate a representative method for treating wastewater including the step of 510, sending wastewater from the at least one inflow pipe and valve assembly 160 coupled to at least one reactor tank assembly 100 into the at least one reactor tank assembly 100 through at least one inlet header port assembly disposed on the top portion of the at least one reactor tank assembly 100. The method further includes the step of 515, mixing the wastewater by way of waterflow pressure generated by at least one circulation pump assembly 9. The method further includes the step of 520, further mixing the wastewater by way of the at least one eductor 110, mixing to substantially uniform intermixing of the at least one or more of acid and caustic introduced to the wastewater within the at least one reactor tank assembly 100. The method further includes the step of 525, sending wastewater from the at least one reactor tank assembly 100 through at least one inflow pipe and valve assembly 170 coupled by at least one outlet port assembly of the at least one reactor tank assembly 100. The method further includes the step of 530, measuring pH by at least one pH sensor 120 disposed within wastewater that has flowed into the outflow pipe. The method further includes the step of 535, if the pH is in an unacceptable range, treating the wastewater by introducing at least one or more of the acid and the caustic into the wastewater flow by way of at least one secondary stream of the wastewater, the carrier-injector pump assembly 19 pumping the secondary stream of wastewater from wastewater flowing through the at least one inflow pipe and valve assembly 170. The method further includes the step of 540, if the pH was in an unacceptable range, sending at least a portion of the treated wastewater, back into at least one reactor tank assembly 100 by way of at least one inflow pipe and valve assembly 180 of the at least one inflow pipe and valve assembly 170. The method further includes the step of 545, if the pH is in an acceptable range, discharging at least a portion of the wastewater from the system for treating wastewater.

FIGS. 5A and 5B illustrate that the method may further include the step of 545, testing wastewater pH after the wastewater has passed through at least one static mixer 13 disposed on the inflow pipe and valve assembly 170, if the pH is inclusively between 5.0 and 8.0, opening the selector valve assembly 15 and allowing the wastewater to flow out of the system for treating wastewater and, if the pH is less than 5.0 or greater than 8.0, closing the selector valve assembly 15 and directing wastewater to flow back into at least one reactor tank assembly 100.

FIGS. 5A and 5B illustrate that the method may further include the step of 550, holding variable wastewater levels within the buffer zone of the at least one reactor assembly. The method may further include the step of 555, circulating variable rates of wastewater flows. The method may further include the step of 560, including water flowing between about 2,500 and 10,000 gallons per minute. The method may further include the step of 565, controlling wastewater flow with at least one circulation pump, buffer zone, and parallel reactor tank assembly 100. The method may further include the step of 570, sending wastewater into the distribution trough and distributing the wastewater substantially evenly over the surface of the wastewater already in the at least one reactor tank assembly 100. The method may further include the step of 575, catching with at least one bag strainer 7 larger particles and debris from the wastewater flow. The method may further include the step of 580, changing between lead-lag and parallel wastewater flows at least one or more of manually and automatically.

FIG. 6 illustrates arrangements for reactor tank assemblies 100 to include lead lag and parallel arrangement as illustrated with six representative elements of pipe and valve assemblies 160, 170, and 180 operationally coupled to 100. Lead lag and parallel flows may occur together.

Various related embodiments of the inventive concept are also described in the drawings filed and labeled Appendix A, which is incorporated herein by reference in its entirety. The following patents are incorporated by reference in their entirety: Pat. Nos. US2018/0162743, U.S. Pat. Nos. 9,884,348, 7,972,507, 3,395,799, CN209721777, CN109553148, KR100500374, KR20030076009, JP2003148400, CN1094469, and JP55018274.

While the inventive concept has been described above in terms of specific embodiments, it is to be understood that the inventive concept is not limited to these disclosed embodiments. Upon reading the teachings of this disclosure, many modifications and other embodiments of the inventive concept will come to mind of those skilled in the art to which this inventive concept pertains, and which are intended to be and are covered by both this disclosure and the appended claims. It is indeed intended that the scope of the inventive concept should be determined by proper interpretation and construction of the appended claims and their legal equivalents, as understood by those of skill in the art relying upon the disclosure in this specification and the attached drawings.

1. A system for treating wastewater comprising:
at least one reactor tank assembly;
the at least one reactor tank assembly operable at least one or more of singly, as a series of reactor tank assemblies, and parallel with other reactor tank assemblies;
at least one inflow pipe and valve assembly coupled to the at least one reactor tank assembly adapted to direct wastewater into the at least one reactor tank assembly through at least one inlet header port assembly disposed on a top portion of the reactor tank assembly;
at least one outflow pipe and valve assembly coupled by at least one outlet port assembly of the at least one reactor tank assembly adapted to direct wastewater out from the at least one reactor tank assembly;
at least one return flow pipe and valve assembly of the at least one outflow pipe and valve assembly adapted to direct, as required, at least a portion of the wastewater flowing out from the at least one reactor tank assembly back into the at least one reactor tank assembly;
at least one circulation pump assembly disposed on the at least one outflow pipe and valve assembly;
at least one carrier-injector pump assembly, the at least one carrier-injector pump assembly adapted to pump a portion of wastewater fed to it as a secondary stream of wastewater flowing through the at least one outflow pipe and valve assembly;
at least one mixer assembly operationally disposed within the at least one reactor tank assembly adapted to mix wastewater in the reactor tank assembly, inclusive, when present, of wastewater drawn from the reactor tank assembly and reintroduced into the reactor tank assembly through the at least one return flow pipe and valve assembly; and
at least one pH sensor assembly disposed at least partially within the wastewater flow and operationally coupled to at least one computer system, the at least one computer system adapted to control introducing at least one or more of acid from an at least one acid storage reactor tank and valve assembly operationally coupled to the wastewater flow and a caustic from an at least one caustic storage reactor tank and valve assembly operationally coupled to the wastewater flow, the at least one or more acid and caustic used to change the pH of the wastewater, the at least one or more acid and caustic introduced to the wastewater as the wastewater flows through one or more streams of the outflow pipe and valve assembly.

2. The system for treating wastewater of claim 1 wherein at least one static mixer is disposed on the outflow pipe and valve assembly and at least one pH sensor is disposed on the outflow pipe and valve assembly following the static mixer, the pH sensor adapted to test wastewater pH after the wastewater has passed through the static mixer and, if the pH is inclusively between 5.0 and 8.0, a selector valve adapted to be open and allow the wastewater to flow out of the system for treating wastewater and, if the pH is less than 5.0 or greater than 8.0, the selector valve assembly adapted to be closed and direct wastewater to flow back into a reactor tank assembly.

3. The system for treating wastewater of claim 1 wherein the at least one reactor tank assembly has a buffer zone suitable for holding variable wastewater levels.

4. The system for treating wastewater of claim 1 wherein flow rate variability ranges inclusively between 2,500 and 10,000 gallons per minute.

5. The system for treating wastewater of claim 4 wherein circulation pump assemblies are adapted to handle varied rates of wastewater flows.

6. The system for treating wastewater of claim 4 wherein flow rate variability ranges are controllable by the at least one circulation pump, buffer zone, and parallel reactor tank assembly.

7. The system for treating wastewater of claim 1 wherein a distribution trough of the at least one reactor tank assembly is adapted to receive wastewater and distribute that wastewater substantially evenly over the surface of wastewater already in the at least one reactor tank assembly.

8. The system for treating wastewater of claim 1 wherein at least one bag strainer disposed on the outflow stream is adapted to catch particles and debris from the wastewater flow.

9. The system for treating wastewater of claim 1 wherein the at least one reactor assembly includes at least one propeller assembly adapted to mix wastewater.

10. A method for treating wastewater comprising:
sending wastewater from at least one inflow pipe and valve assembly coupled to at least one reactor tank assembly into the at least one reactor tank assembly through at least one inlet header port assembly disposed on a top portion of the at least one reactor tank assembly;
mixing the wastewater by way of waterflow pressure generated by at least one circulation pump assembly;
further mixing the wastewater by way of at least one mixer assembly,
mixing to substantially uniform intermixing of an at least one or more of acid and caustic introduced to the wastewater within the at least one reactor tank assembly;
sending wastewater from the at least one reactor tank assembly through at least one outflow pipe and valve assembly coupled by at least one outlet port assembly of the at least one reactor tank assembly;
measuring pH by at least one pH sensor disposed within wastewater that has flowed into the outflow pipe;
if the pH is in an unacceptable range, treating the wastewater by introducing at least one or more of an acid and a caustic into the wastewater flow by way of at least one secondary stream of the wastewater, a carrier-injector pump assembly pumping the secondary stream of wastewater from wastewater flowing through the at least one outflow pipe and valve assembly;
if the pH was in an unacceptable range, sending at least a portion of the treated wastewater, back into at least one reactor tank assembly by way of at least one return flow pipe and valve assembly of the at least one outflow pipe and valve assembly; and
if the pH is in an acceptable range, discharging at least a portion of the wastewater from the system for treating wastewater.

11. The method for treating wastewater of claim 10 including testing wastewater pH after the wastewater has passed through at least one static mixer disposed on the outflow pipe and valve assembly, if the pH is inclusively between 5.0 and 8.0, opening a selector valve assembly and allowing the wastewater to flow out of the system for treating wastewater and, if the pH is less than 5.0 or greater than 8.0, closing the selector valve assembly and directing wastewater to flow back into at least one reactor tank assembly.

12. The method for treating wastewater of claim 10 including holding variable wastewater levels within a buffer zone of the at least one reactor assembly.

13. The method for treating wastewater of claim 12 including circulating variable rates of wastewater flows.

14. The method for treating wastewater of claim 13 including water flowing between about 2,500 and 10,000 gallons per minute.

15. The method for treating wastewater of claim 10 including controlling wastewater flow with at least one circulation pump, buffer zone, and parallel reactor tank assembly.

16. The method for treating wastewater of claim 10 including sending wastewater into a distribution trough and distributing the wastewater substantially evenly over the surface of the wastewater already in the at least one reactor tank assembly.

17. The method for treating wastewater of claim 10 including catching with at least one bag strainer larger particles and debris from the wastewater flow.

18. The method for treating wastewater of claim 10 including changing between lead-lag and parallel wastewater flows at least one or more of manually and automatically.

19. A system for treating wastewater comprising:
at least one reactor tank assembly;
a distribution trough of the at least one reactor tank assembly adapted to receive wastewater and distribute that wastewater substantially evenly over the surface of wastewater already in the at least one reactor tank assembly;
the at least one reactor tank assembly adapted to be operable in lead-lag flows and parallel flows with at least one second reactor tank assembly, changes between lead-lag flow and parallel flow adapted to be enacted at least one or more of manually and automatically;
at least one inflow pipe and valve assembly coupled to the at least one reactor tank assembly adapted to direct wastewater into the at least one reactor tank assembly through at least one inlet header port assembly disposed on a top portion of the at least one reactor tank assembly;
at least one outflow pipe and valve assembly coupled by at least one outlet port assembly of the at least one reactor tank assemblies adapted to direct wastewater out from the at least one reactor tank assemblies;
at least one return flow pipe and valve assembly of the at least one outflow pipe and valve assembly adapted to direct, as required, at least a portion of the wastewater flowing out from the at least one reactor tank assemblies back into at least one reactor tank assembly;
at least one circulation pump assembly disposed on the at least one outflow pipe and valve assembly;
at least one carrier-injector pump assembly, the at least one carrier-injector pump assembly adapted to pump a portion of wastewater fed to it as a secondary stream of wastewater flowing through the at least one outflow pipe and valve assembly;
at least one mixer assembly operationally disposed within each reactor tank assembly adapted to mix wastewater in the at least one reactor tank assemblies, inclusive, when present, of wastewater drawn from at least one reactor tank assembly and reintroduced into the at least one reactor tank assemblies through the at least one return flow pipe and valve assembly;
at least one pH sensor assembly disposed at least partially within the wastewater flow and operationally coupled to at least one computer system, the at least one computer system adapted to control introducing at least one or more of acid from an at least one acid storage reactor tank and valve assembly operationally coupled to the wastewater flow and a caustic from an at least one caustic storage reactor tank and valve assembly operationally coupled to the wastewater flow, the at least one or more acid and caustic used to change the pH of the wastewater, the at least one or more acid and caustic introduced to the wastewater as the wastewater flows through one or more streams of the outflow pipe and valve assembly; and
one or more from a group of: temperature sensors disposed within the at least one or more of the reactor tank assemblies and pipe and valve assemblies, pressure sensors disposed within at least one or more of the reactor tank assemblies, and flow sensors disposed within at least one or more of the pipe and valve assemblies.

20. The system for treating wastewater of claim 19 wherein at least one static mixer is disposed on the outflow pipe and valve assembly and at least one pH sensor is disposed on the outflow pipe and valve assembly following the static mixer, the pH sensor adapted to test wastewater pH after the wastewater has passed through the static mixer and, if the pH is inclusively between 5.0 and 8.0, a selector valve adapted to be open and allow the wastewater to flow out of the system for treating wastewater and, if the pH is less than 5.0 or greater than 8.0, the selector valve assembly adapted to be closed and direct wastewater to flow back into a reactor tank assembly.

21. The system for treating wastewater of claim 19 wherein the at least one reactor tank assembly has a buffer zone suitable for holding variable wastewater levels.

22. The system for treating wastewater of claim 19 wherein flow rate variability ranges inclusively between 2,500 and 10,000 gallons per minute.

23. The system for treating wastewater of claim 22 wherein circulation pump assemblies are adapted to handle varied rates of wastewater flows.

24. The system for treating wastewater of claim 22 wherein flow rate variability ranges are controllable by the at least one circulation pump, buffer zone, and parallel reactor tank assembly.

25. The system for treating wastewater of claim 19 wherein at least one bag strainer disposed on the outflow stream is adapted to catch particles and debris from the wastewater flow.

26. The system for treating wastewater of claim 19 wherein the at least one reactor assembly includes at least one propeller assembly adapted to mix wastewater.
